(19) United States
(12) Patent Application Publication
(10) Pub. No.: US 2018/0046026 A1
(43) Pub. Date: Feb. 15, 2018

(54) LIQUID CRYSTAL DISPLAY AND ELECTRONIC DEVICE

(71) Applicants: BOE TECHNOLOGY GROUP CO., LTD., Beijing (CN); BEIJING BOE OPTOELECTRONICS TECHNOLOGY CO., LTD., Beijing (CN)

(72) Inventors: Lei WANG, Beijing (CN); Xiaochuan CHEN, Beijing (CN); Rui XU, Beijing (CN); Wenqing ZHAO, Beijing (CN); Qian WANG, Beijing (CN); Ming YANG, Beijing (CN); Pengcheng LU, Beijing (CN); Jian GAO, Beijing (CN); Xiaochen NIU, Beijing (CN); Shengji YANG, Beijing (CN)

(21) Appl. No.: 15/529,923

(22) PCT Filed: May 18, 2016
(86) PCT No.: PCT/CN2016/082444

§ 371 Date: May 25, 2017

(30) Foreign Application Priority Data
Mar. 3, 2016 (CN) 201610122020.5

(51) Int. Cl. G02F 1/1335; G06F 3/01; G02F 1/1343

(52) U.S. Cl. CPC G02F 1/133602; G02F 1/1343; G06F 3/013; G02F 1/133528; G02F 2001/133607; G02F 1/133514

(57) ABSTRACT

A liquid crystal display and an electronic device are disclosed. The control unit applies voltages to sub-electrodes and a first transparent electrode according to image data to generate electric fields, so that liquid crystal molecules in regions of the liquid crystal layer corresponding to electrode units are deflected to form micro-prism structures, and the control unit controls the micro-prism structures by controlling magnitude of voltages on the sub-electrodes in the electrode units, thereby controlling an energy distribution ratio of emergent light resulted from refraction of the backlight′ light by the micro-prism structures and in a preset viewing angle range. Accordingly, luminance of light entering into the preset viewing angle range can be realized through controlling the micro-prism structures, thereby realizing gray scale display.

### RELATED APPLICATIONS

The present application is the U.S. national phase entry of PCT/CN2016/082444, with an international filing date of May 18, 2016, which claims the benefit of Chinese Patent Application No. 201610122020.5, filed on Mar. 3, 2016, the entire disclosures of which are incorporated herein by reference.

### TECHNICAL FIELD

The present disclosure relates to the technical field of display, and in particular to a liquid crystal display and an electronic device.

### BACKGROUND

An existing liquid crystal display panel generally includes an array substrate and a color film substrate arranged facing each other, a liquid crystal layer, a common electrode and a pixel electrode located between the array substrate and the color film substrate, as well as polarizers disposed on the array substrate and the color film substrate, respectively.

The principle of display of the existing liquid crystal display panel is that natural light is converted into linearly polarized light by the polarizer on the array substrate, and voltages are applied to the pixel electrodes and the common electrodes to form electric fields on both sides of the liquid crystal layer; liquid crystal molecules in the liquid crystal layer rotate under the effect of the electric fields, thereby changing a polarization state of the linearly polarized light; then the polarizer on the color film substrate analyses polarization of the linearly polarized light, and the polarization state can be controlled by controlling magnitude of the electric fields; different polarization states imply different transmittances of light emitted from the liquid crystal display panel, thus realizing gray scale display of images.

### SUMMARY

An embodiment of the present disclosure provides a liquid crystal display for realizing a wide viewing angle display.

A liquid crystal display provided by an embodiment of the present disclosure comprises a backlight, a lower substrate at a light emergent side of the backlight, an upper substrate disposed opposing to the lower substrate, and a liquid crystal layer located between the upper substrate and the lower substrate; and further comprises a first transparent electrode and a second transparent electrode respectively located on both sides of the liquid crystal layer, and a control unit for applying voltages to the first transparent electrode and the second transparent electrode; and wherein,

the first transparent electrode is a planar electrode; the second transparent electrode includes a plurality of electrode units, each including a plurality of sub-electrodes arranged in parallel; the control unit is used for applying voltages to the sub-electrodes and the first transparent electrode according to image data when displaying, so that liquid crystal molecules in regions of the liquid crystal layer corresponding to the electrode units are deflected to form micro-prism structures, and for controlling the micro-prism structures by controlling magnitude of voltages on the sub-electrodes in the electrode units, thereby controlling an energy distribution ratio of a preset viewing angle range of emergent light resulted from refraction of the backlight's light by the micro-prism structures.

In certain exemplary embodiments, the first transparent electrode and the second transparent electrode are located between the upper substrate and the lower substrate.

In certain exemplary embodiments, the liquid crystal display provided by the embodiment of the present disclosure further comprises a light color conversion layer at a side of the liquid crystal layer facing away from the lower substrate; and wherein, the light color conversion layer is used for converting, into light of at least one color, light in regions corresponding to the micro-prism structures and transmitted through the liquid crystal layer, and light from the backlight is converted into light of at least three colors after being transmitted through the light color conversion layer.

In certain exemplary embodiments, in the liquid crystal display provided by the embodiment of the present disclosure, the light color conversion layer is a light splitting film or a color filter film.

In certain exemplary embodiments, in the liquid crystal display provided by the embodiment of the present disclosure, light emitted from the backlight is quasi linear light or parallel light.

In certain exemplary embodiments, the liquid crystal display provided by the embodiment of the present disclosure further comprises a human eye tracking unit;

the human eye tracking unit is used for determining a preset viewing angle range by tracking a target human eye, and sending the determined preset viewing angle range to the control unit; and

the control unit adjusts voltages applied to the sub-electrodes in the electrode units according to the preset viewing angle range.

In certain exemplary embodiments, in the liquid crystal display provided by the embodiment of the present disclosure, the first transparent electrode is located at a side of the upper substrate facing the liquid crystal layer, and the second transparent electrode is located at a side of the lower substrate facing the liquid crystal layer; or the second transparent electrode is located at the side of the upper substrate facing the liquid crystal layer, and the first transparent electrode is located at the side of the lower substrate facing the liquid crystal layer.

In certain exemplary embodiments, in the liquid crystal display provided by the embodiment of the present disclosure, the thicker an equivalent optical path of the micro-prism structure in a direction along a cell thickness of the liquid crystal display, the smaller a difference between voltages applied to the transparent electrodes on both sides of the liquid crystal layer corresponding to the micro-prism structure.

In certain exemplary embodiments, in the liquid crystal display provided by the embodiment of the present disclosure, the sub-electrodes have a shape of a curved line.

In certain exemplary embodiments, in the liquid crystal display provided by the embodiment of the present disclosure, the shape of a curved line is a corrugated shape.

In certain exemplary embodiments, in the liquid crystal display provided by the embodiment of the present disclosure, the sub-electrodes have a polyline shape.

In certain exemplary embodiments, in the liquid crystal display provided by the embodiment of the present disclosure, the polyline shape is to a sawtooth shape.

In certain exemplary embodiments, the liquid crystal display provided by the embodiment of the present disclosure further comprises a first polarizer located between the lower substrate and the backlight.

In certain exemplary embodiments, the liquid crystal display provided by the embodiment of the present disclosure further comprises a second polarizer located at a side of the upper substrate facing away from the liquid crystal layer, and a direction of transmission axis of the second polarizer is parallel to a direction of transmission axis of the first polarizer.

In certain exemplary embodiments, in the liquid crystal display provided by the embodiment of the present disclosure, the micro-prism structures are triangular prism structures or quadrilateral prism structures.

An embodiment of the present disclosure further provides an electronic device, which comprises the liquid crystal display described in the above embodiments.

For the liquid crystal display and the electric device provided by the embodiment of the present disclosure, when displaying, the control unit applies voltages to the sub-electrodes and the first transparent electrode according to image data to generate electric fields so that liquid crystal molecules in regions of the liquid crystal layer corresponding to the electrode units are deflected to form micro-prism structures, and the control unit controls magnitude of voltages on the sub-electrodes in the electrode units to control micro-prism structures, thereby controlling an energy distribution ratio of emergent light in a preset viewing angle range that is resulted from refraction of the backlight′ light by the micro-prism structures. Accordingly, luminance of light entering into the preset viewing angle range can be realized through controlling the micro-prism structures, thereby realizing gray scale display. Also, since the sub-electrodes have a curved shape or a polyline shape, the micro-prism structures may have a plurality of different refraction directions so as to emit light from a plurality of angles, thereby extending the viewing angle range of the liquid crystal display and realizing wide viewing angle display.

### BRIEF DESCRIPTION OF THE DRAWINGS

FIGS. 1a and 1b are respectively schematic structural diagrams of liquid crystal displays provided by embodiments of the present disclosure;

FIGS. 2a-2d are respectively schematic diagrams of principles of micro-prism structures in a liquid crystal display provided by an embodiment of the present disclosure realizing gray scale display;

FIGS. 3a-3d are respectively schematic diagrams of principles of micro-prism structures in a liquid crystal display provided by an embodiment of the present disclosure realizing gray scale display;

FIGS. 4a-4g are respectively schematic diagrams of principles of micro-prism structures in a liquid crystal display provided by the embodiment of the present disclosure realizing gray scale display;

FIG. 5 is a schematic diagram of relationship between micro-prism structures in a liquid crystal display provided by an embodiment of the present disclosure and voltages on corresponding sub-electrodes;

FIGS. 6a and 6b are respectively schematic diagrams of shapes of sub-electrodes in a liquid crystal display provided by an embodiment of the present disclosure;

FIGS. 7a and 7b are respectively structural schematic diagrams of liquid crystal displays provided by embodiments of the present disclosure;

FIGS. 8a and 8b are respectively structural schematic diagrams of liquid crystal displays provided by embodiments of the present disclosure.

### DETAILED DESCRIPTION OF EMBODIMENTS

To make the objects, technical solutions and advantages of the present disclosure clearer, the present disclosure will be further described in detail below in connection with the drawings. It is obvious that the described embodiments are merely some instead of all of embodiments of the present disclosure. All other embodiments that can be obtained by those ordinary skills in the art on the basis of embodiments in the present disclosure without undue experimentation fall into the protected scope of the present disclosure.

Shapes and sizes of components in the Figures do not reflect true proportion, but are only intended to schematically explain the present disclosure.

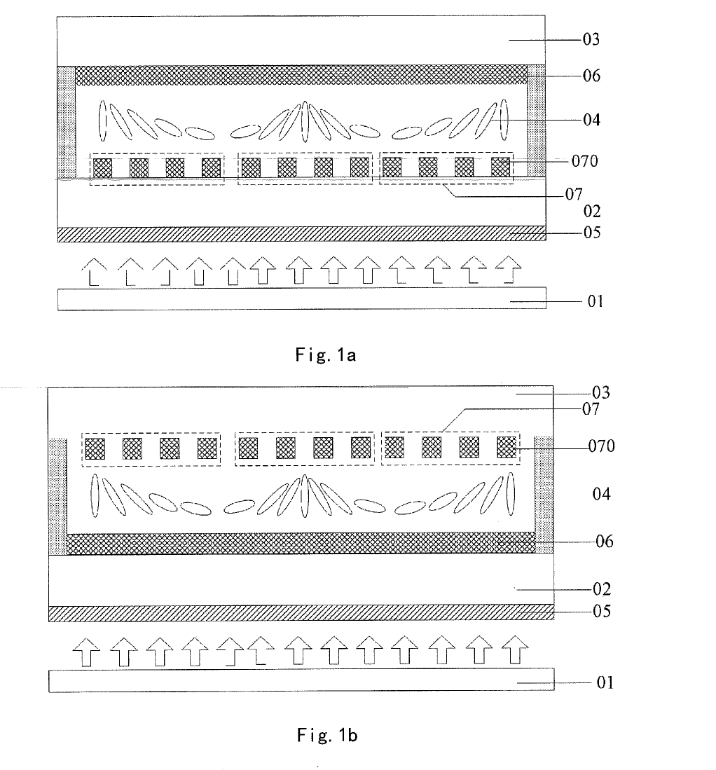

A liquid crystal display provided by an embodiment of the present disclosure, as shown in FIGS. 1a and 1b, comprises a backlight 01, a lower substrate 02 at a light emergent side of the backlight 01, an upper substrate 03 arranged opposing to the lower substrate 02, and a liquid crystal layer 04 located between the upper substrate 03 and the lower substrate 02; and further comprises:

a first transparent electrode 06 and a second transparent electrode respectively located on both sides of the liquid crystal layer 04, and a control unit (not shown in the figures) for applying voltages to the first transparent electrode 06 and the second transparent electrode; and wherein,

the first transparent electrode 06 is a planar electrode; the second transparent electrode includes a plurality of electrode units 07, each including a plurality of sub-electrodes 070 arranged in parallel;

the control unit is used for applying voltages to the sub-electrodes 070 and the first transparent electrode 06 according to image data when displaying, so that liquid crystal molecules in regions of the liquid crystal layer 04 corresponding to the electrode units 07 are deflected to form micro-prism structures, and for controlling magnitude of voltages on the sub-electrodes 070 in the electrode units 07 to control the micro-prism structures, thereby controlling an energy distribution ratio of emergent light in a preset viewing angle range that is resulted from refraction of the backlight 01's light by the micro-prism structures.

For the liquid crystal display provided by the embodiment of the present disclosure, when displaying, the control unit applies voltages to the sub-electrodes and the first transparent electrode according to image data to generate electric fields so that liquid crystal molecules in regions of the liquid crystal layer corresponding to the electrode units are deflected to form micro-prism structures, and the control unit controls magnitude of voltages on the sub-electrodes in the electrode units to control micro-prism structures, thereby controlling an energy distribution ratio of a preset viewing angle range of emergent light resulted from refraction of the backlight′ light by the micro-prism structures. Accordingly, luminance of light entering into the preset viewing angle range can be realized through controlling the micro-prism structures, thereby realizing gray scale display. Also, since the sub-electrodes have a curved shape or a polyline shape, the micro-prism structures may have a plurality of different refraction directions so as to emit light from a plurality of angles, thereby extending the viewing angle range of the liquid crystal display and realizing wide viewing angle display.

It is to be noted that in the liquid crystal display provided by the embodiment of the present disclosure, the energy distribution ratio of the emergent light in the preset viewing angle range refers to a ratio of energy of a part of emergent light resulted from refraction of the backlight's light by a micro-prism structure and irradiated within the preset viewing angle range to energy of all emergent light resulted from refraction of the backlight's light by the micro-prism structure.

In specific implementation, in the liquid crystal display provided by the embodiment of the present disclosure, as shown in FIG. 1a, the first transparent electrode 06 is located at a side of the upper substrate 03 facing the liquid crystal layer 04, and the second transparent electrode (including the electrode units 07 in the figure) is located at a side of the lower substrate 02 facing the liquid crystal layer 04;

alternatively, as shown in FIG. 1b, the second transparent electrode (including the electrode units 07 in the figure) is located at the side of the upper substrate 03 facing the liquid crystal layer 04, and the first transparent electrode 06 is located at the side of the upper substrate 03 facing the liquid crystal layer 04, which is not limited herein.

In certain exemplary embodiments, the first transparent electrode 06 and the second transparent electrode are located between the upper substrate 03 and the lower substrate 02. By means of the above arrangement, liquid crystal molecules in the liquid crystal layer 04 can be controlled more precisely.

The principle of the present disclosure will be explained in detail below in conjunction with specific embodiments. It is to be noted that the embodiments are intended to better illustrate the present disclosure, but not intended to limit the present disclosure.

Specifically, micro-prism structures in regions to the left and right of and right in front of a target human eye are taken as examples to illustrate the principle that by controlling micro-prism structures, the energy distribution ratio of light emitted from the micro-prism structures within a preset viewing angle range can be controlled so as to realize gray scale display.

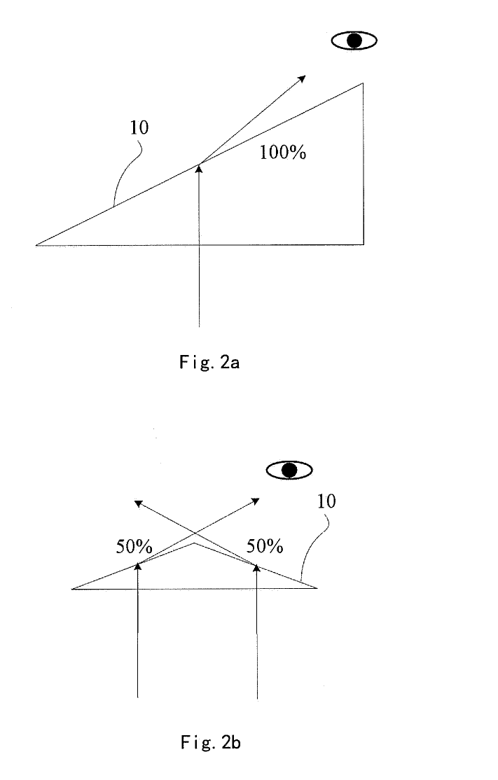

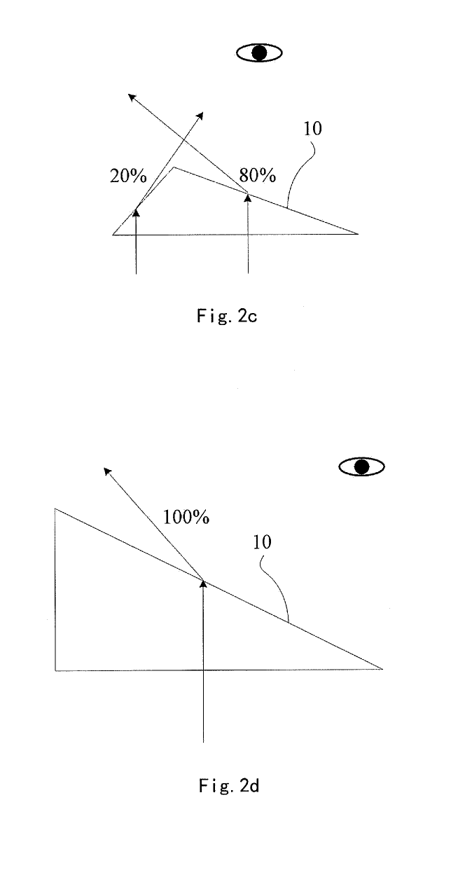

Specifically, as shown in FIGS. 2a-2d, when the target human eye is to the right of the micro-prism structure 10, light refracted to the right by the micro-prism structure 10 enters the target human eye. As shown in FIG. 2a, when the micro-prism structure 10 is a right angle triangular prism and the hypotenuse of the right angle triangular prism is at a side far away from the target human eye, light refracted by the micro-prism structure 10 all irradiates towards the target human eye; namely, the energy distribution ratio of emergent light entering into the target human eye is 100%, so high gray scale display can be realized. As shown in FIG. 2b, when the micro-prism structure 10 is an isosceles triangular prism, half of light refracted by the micro-prism structure 10 irradiates toward the target human eye. Namely, the energy distribution ratio of emergent light entering into the target human eye is 50%, and thus medium gray scale display can be realized. As shown in FIG. 2c, when the micro-prism structure 10 is an ordinary triangular prism and the shortest side of the ordinary triangular prism is at a side far away from the target human eye, a small part of light refracted by the micro-prism structure 10 irradiates toward the target human eye. The energy distribution ratio of the emergent light entering into the target human eye is hypothetically 20%, and thus a medium-low gray scale display can be realized. As shown in FIG. 2d, when the micro-prism structure 10 is a right angle triangular prism and the hypotenuse of the right angle triangular prism is at a side near the target human eye, no light irradiates toward the target human eye and thus low gray scale display can be realized.

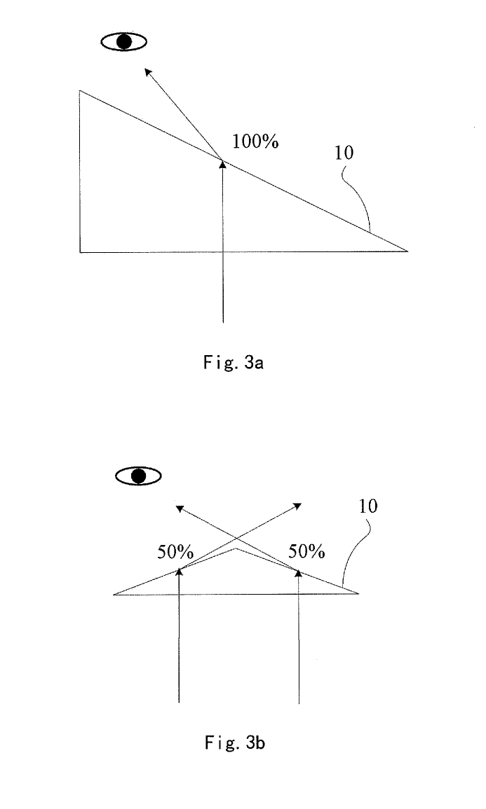

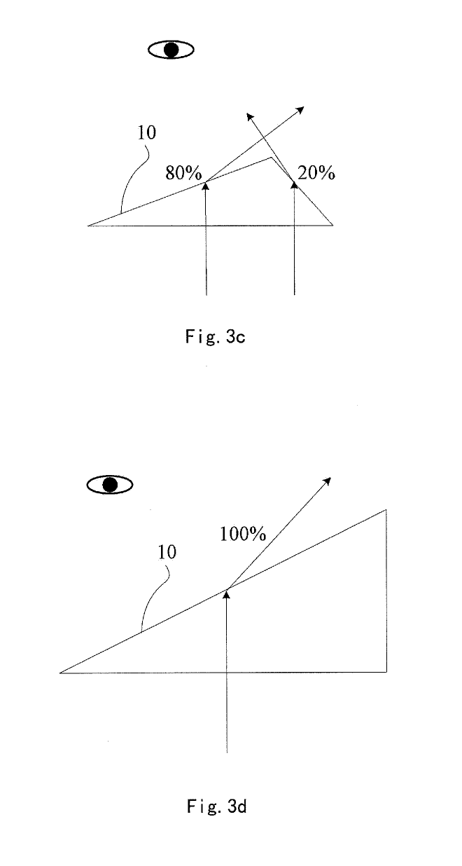

Specifically, as shown in FIGS. 3a-3d, when the target human eye is to the left of the micro-prism structure 10, light refracted to the left by the micro-prism structure 10 enters into the target human eye. As shown in FIG. 3a, when the micro-prism structure 10 is a right angle triangular prism and the hypotenuse of the right angle triangular prism is at a side far away from the target human eye, light refracted by the micro-prism structure 10 all irradiates toward the target human eye. Namely, the energy distribution ratio of emergent light entering into the target human eye is 100%, and thus high gray scale display can be realized. As shown in FIG. 3b, when the micro-prism structure 10 is an isosceles triangular prism, half of light refracted by the micro-prism structure 10 irradiates toward the target human eye. Namely, the energy distribution ratio of emergent light entering into the target human eye is 50%, and thus medium gray scale display can be realized. As shown in FIG. 3c, when the micro-prism structure 10 is an ordinary triangular prism and the shortest side of the ordinary triangular prism is at a side far away from the target human eye, a small part of light refracted by the micro-prism structure 10 irradiates toward the target human eye. The energy distribution ratio of the emergent light entering into the target human eye is hypothetically 20%, and thus a medium-low gray scale display can be realized. As shown in FIG. 3d, when the micro-prism structure 10 is a right angle triangular prism and the hypotenuse of the right angle triangular prism is at a side near the target human eye, no light irradiates toward the target human eye, and thus low gray scale display can be realized.

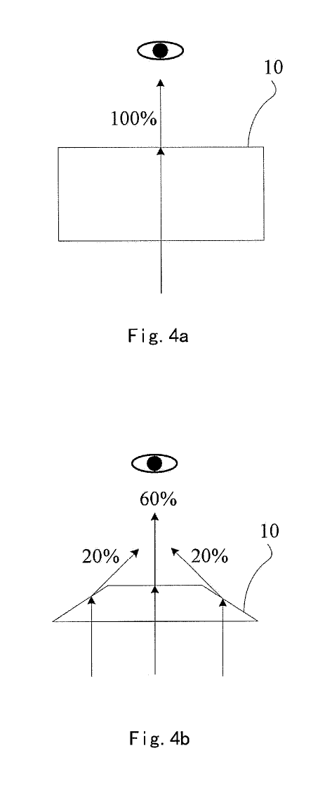

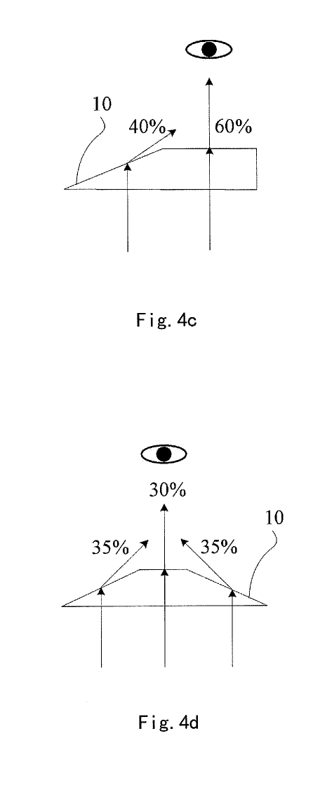

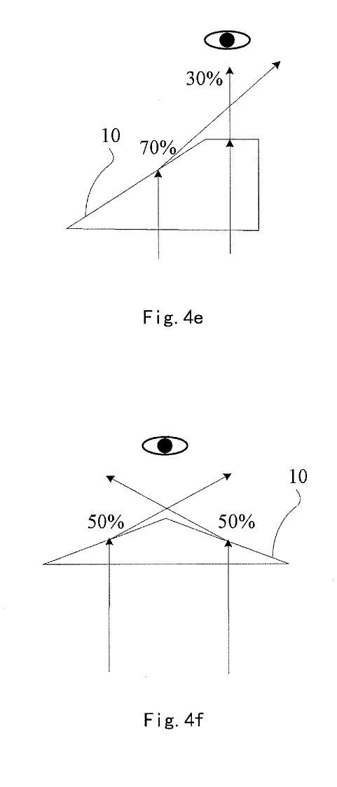

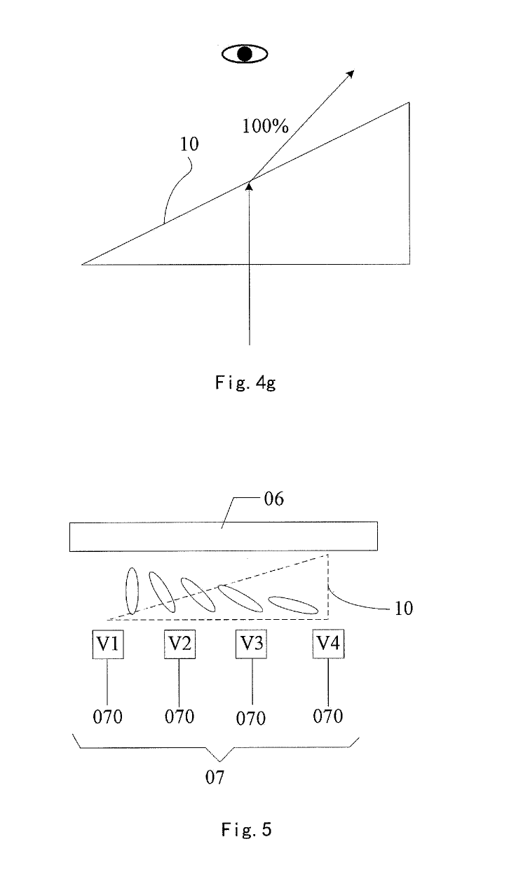

Specifically, as shown in FIGS. 4a-4g, when the target human eye is right in front of the micro-prism structure 10, light refracted straight ahead by the micro-prism structure 10 enters the target human eye. As shown in FIG. 4a, when the micro-prism structure 10 is a rectangular prism, light to refracted by the micro-prism structure 10 all irradiates towards the target human eye. Namely, the energy distribution ratio of emergent light entering into the target human eye is 100%, and thus high gray scale display can be realized. As shown in FIGS. 4b-4e, when the micro-prism structure 10 is a trapezoidal prism and the shorter bottom side of the trapezoidal prism is at a side near the target human eye, a part of light refracted by the micro-prism structure 10 irradiates towards the target human eye, and thus medium gray scale display can be realized. Specifically, a percentage of light irradiated towards the target human eye can be adjusted by adjusting relative lengths of the two bottom sides of the trapezoidal prism. Hypothetically, the energy distribution ratio of emergent light entering into the target human eye is 60% in FIGS. 4b and 4c, and the energy distribution ratio of emergent light entering into the target human eye is 30% in FIGS. 4d and 4e. As shown in FIGS. 4f and 4g, when the micro-prism structure 10 is a triangular prism, no light is refracted straight ahead by the micro-prism structure 10. Namely, no light irradiates towards the target human eye, and thus low gray scale display can be realized.

The above illustrates, only by way of examples of specific micro-prism structures, the principle of how to control the energy distribution ratio of the emergent light from the micro-prism structures within a preset viewing angle range to realize gray scale display. The specific micro-prism structures can also be other structures that can realize a solution of the embodiment of the present disclosure. The micro-prism structures are controlled by controlling sizes of the first transparent electrode and the sub-electrodes according to an image data, which is not limited herein. In addition, the eye shown in FIGS. 2a-4g are only for showing directions of the target human eye, and in specific implementation, the size of the eye can be corresponding to a plurality of micro-prism structures.

It is to be noted that in the liquid crystal display provided by the embodiment of the present disclosure, the micro-prism structures shown in FIGS. 2a-4g are all illustrated by taking an example that the micro-prism structure has a surface facing the human eye.

Further, in specific implementation, in the liquid crystal display provided by the embodiment of the present disclosure, the thicker the equivalent optical path of a micro-prism structure in a direction along a cell thickness of the liquid crystal display, the smaller the difference between voltages applied to the transparent electrodes on both sides of the liquid crystal layer corresponding to the micro-prism structure. Take the micro-prism structure being a right angle prism for example. As shown in FIG. 5, it is assumed that one electrode unit 07 includes four sub-electrodes 070 arranged in parallel and the sub-electrodes 070 have a shape of a straight line. Accordingly, in FIG. 5, voltages on the four sub-electrodes 070 from left to right are V1, V2, V3 and V4, respectively, and V1>V2>V3>V4, and the equivalent optical paths of the micro-prism structures 10 become thicker and thicker. FIG. 5 is illustrated by taking an example that the sub-electrodes 070 have a shape of a straight line. It can be seen from FIG. 5 that a right angle prism formed when the sub-electrodes 070 have a shape of a straight line emits light in few directions, and the viewing angle is small accordingly.

Therefore, in the liquid crystal display provided by the embodiment of the present disclosure, the sub-electrodes may have a shape of a curved line or a polyline. By forming micro-prism structures having a plurality of refraction directions, the viewing angle range can be extended. Moreover, in specific implementation, the more directions the sub-electrodes have, the wider the viewing angle is.

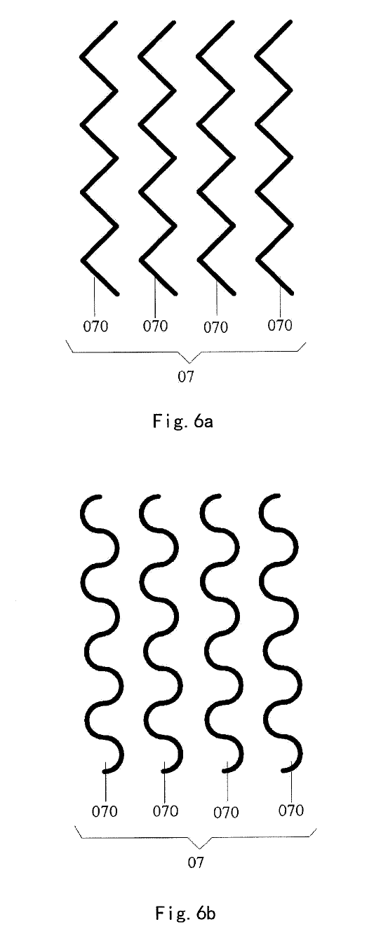

In certain exemplary embodiments, in specific implementation, in the liquid crystal display provided by the embodiment of the present disclosure, the polyline shape of the sub-electrodes 070 is a sawtooth shape, as shown in FIG. 6a.

In certain exemplary embodiments, in specific implementation, in the liquid crystal display provided by the embodiment of the present disclosure, the curved line shape of the sub-electrodes 070 is a corrugated shape, as shown in FIG. 6b.

In the liquid crystal display provided by the embodiment of the present disclosure, the gray scale is controlled by means of the energy distribution ratio of the emergent light from the micro-prism structures within a preset viewing angle range. Light of the backlight is generally circularly polarized light, and thus light of the backlight can be converted into linearly polarized light by a first polarizer 05 disposed on the lower substrate, and the energy distribution ratio of the emergent light within a preset viewing angle range can be precisely controlled by controlling the micro-prism structures.

Further, in specific implementation, in order to control an energy distribution ratio of an emergent light from a micro-prism structure within a preset viewing angle range by controlling the micro-prism structure, it is required to ensure light irradiated from the backlight onto the liquid crystal prism display panel has the same incident direction. Therefore, in certain exemplary embodiments, in the liquid crystal display provided by the embodiment of the present disclosure, the light emitted from the backlight is quasi linear light or parallel light.

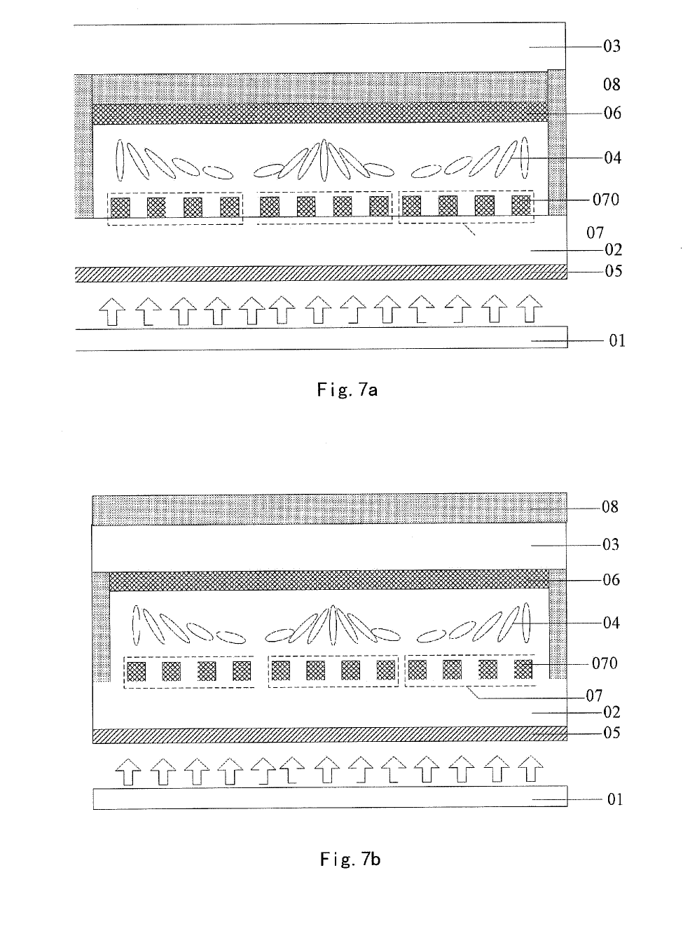

Further, in order to realize color display, the liquid crystal display provided by the embodiment of the present disclosure further comprises a light color conversion layer 08 located at a side of the liquid crystal layer 04 facing away from the lower substrate 02, as shown in FIGS. 7a and 7b. The light color conversion layer 08 is used for converting into light of at least one color, light in regions corresponding to the micro-prism structures and transmitted through the liquid crystal layer 04, and light from the backlight 01 is converted into light of at least three colors after being transmitted through the light color conversion layer 08.

It is to be noted that light of one color herein is equivalent to one sub-pixel in the existing liquid crystal display, and thus in the liquid crystal display provided by the embodiment of the present disclosure, one micro-prism structure corresponds to at least one sub-pixel, while the liquid crystal display includes sub-pixels of at least three colors, such as red sub-pixels, blue sub-pixels and green sub-pixels of the three primary colors, which is not limited herein.

In certain exemplary embodiments, in the liquid crystal display provided by the embodiment of the present disclosure, one micro-prism structure corresponds to one sub-pixel, i.e. the light color conversion layer converts light in regions corresponding to the micro-prism structures into light of only one color.

In specific implementation, in the liquid crystal display provided by the embodiment of the present disclosure, as shown in FIG. 7a, the light color conversion layer 08 can be embedded between the upper substrate 03 and the lower substrate 02, but of course, the light color conversion layer 08 can also be disposed at a side of the upper substrate 03 facing away from the liquid crystal layer 04, which is not limited herein.

Further, in the liquid crystal display provided by the embodiment of the present disclosure, the light color conversion layer 08 is a light splitting film or a color filter film, which includes filters of at least one color; each filter may correspond to, for example, one micro-prism structure, which is not limited herein.

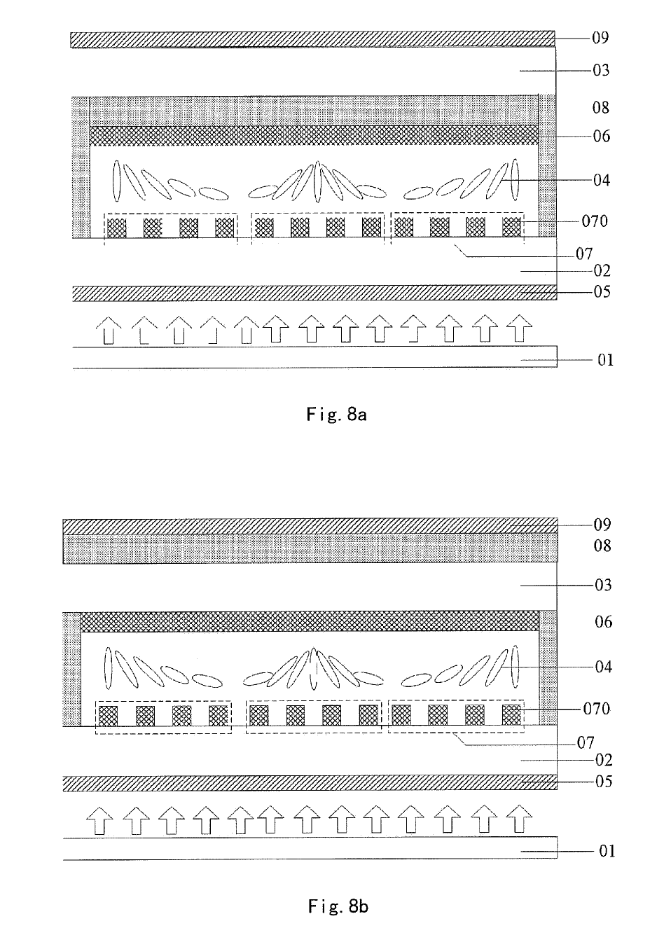

In certain exemplary embodiments, as shown in FIGS. 8a and 8b, the liquid crystal display provided by the embodiment of the present disclosure further comprises a second polarizer 09 disposed at a side of the upper substrate 03 facing away from the liquid crystal layer 04, and a direction of transmission axis of the second polarizer 09 is parallel to a direction of transmission axis of the second polarizer 09, so that the second polarizer 09 further linearly polarizes light emitted from the liquid crystal display, which may effectively improve the display effect.

Further, in the liquid crystal display provided by the embodiment of the present disclosure, the preset viewing angle range can be fixed in a certain range, so that the control unit can control, according to image data, the energy distribution ratio of light emitted from the micro-prism structures within the preset viewing angle range. However, when the target human eye is beyond the preset viewing angle range, it is impossible to view normally. Therefore, In certain exemplary embodiments, the liquid crystal display provided by the embodiment of the present disclosure further comprises a human eye tracking unit;

the human eye tracking unit is used for determining a preset viewing angle range by tracking a target human eye, and sending the determined preset viewing angle range to the control unit;

the control unit adjusts voltages applied to the sub-electrodes in the electrode units according to the preset viewing angle range.

Based on the same inventive concept, an embodiment of the present disclosure further provides an electronic device comprising the liquid crystal display provided by the embodiment of the present disclosure. The electronic device can be any product or component having a lighting or display function, such as a lighting device, a cell phone, a tablet computer, a television, a display, a notebook computer, a digital photo frame and a navigator. As for implementation of the electronic device, reference can be made to the above embodiments for the liquid crystal display, and thus it will not be repeated anymore.

For the liquid crystal display and the electric device provided by the embodiment of the present disclosure, when displaying, the control unit applies voltages to the sub-electrodes and the first transparent electrode according to image data to generate electric fields so that liquid crystal molecules in regions of the liquid crystal layer corresponding to the electrode units are deflected to form micro-prism structures, and the control unit controls magnitude of voltages on the sub-electrodes in the electrode units to control micro-prism structures, thereby controlling an energy distribution ratio of emergent light in a preset viewing angle range that is resulted from refraction of the backlight′ light by the micro-prism structures. Accordingly, luminance of light entering into the preset viewing angle range can be realized through controlling the micro-prism structures, thereby realizing gray scale display. Also, since the sub-electrodes have a curved shape or a polyline shape, the micro-prism structures may have a plurality of different refraction directions so as to emit light from a plurality of angles, thereby extending the viewing angle range of the liquid crystal display and realizing wide viewing angle display.

It is apparent that those skilled in the art can make various modifications and variants to the present disclosure without departing from the spirit and scope of the present disclosure. As such, the modifications and variants are intended to be included herein, if they fall into the scope of the present disclosure defined by the appended claims and their equivalents.

1. A liquid crystal display comprising: a backlight, a lower substrate at a light emergent side of the backlight, an upper substrate disposed opposing to the lower substrate, and a liquid crystal layer located between the upper substrate and the lower substrate; and
a first transparent electrode and a second transparent electrode respectively located on both sides of the liquid crystal layer, and a control unit for applying voltages to the first transparent electrode and the second transparent electrode; and wherein,
the first transparent electrode is a planar electrode; the second transparent electrode includes a plurality of electrode units, each including a plurality of sub-electrodes arranged in parallel;
the control unit is used for applying voltages to the sub-electrodes and the first transparent electrode according to image data when displaying, so that liquid crystal molecules in regions of the liquid crystal layer corresponding to the electrode units are deflected to form micro-prism structures, and for controlling the micro-prism structures by controlling magnitude of voltages on the sub-electrodes in the electrode units, thereby controlling an energy distribution ratio of a preset viewing angle range of emergent light resulted from refraction of the backlight′ light by the micro-prism structures.

2. The liquid crystal display according to claim 1, wherein the first transparent electrode and the second transparent electrode are located between the upper substrate and the lower substrate.

3. The liquid crystal display according to claim 1, further comprising a light color conversion layer at a side of the liquid crystal layer facing away from the lower substrate; and wherein,
the light color conversion layer is used for converting, into light of at least one color, light in regions corresponding to the micro-prism structures and transmitted through the liquid crystal layer, and light from the backlight is converted into light of at least three colors after being transmitted through the light color conversion layer.

4. The liquid crystal display according to claim 3, wherein the light color conversion layer is a light splitting film or a color filter film.

5. The liquid crystal display according to claim 1, wherein light emitted from the backlight is quasi linear light or parallel light.

6. The liquid crystal display according to claim 1, further comprising a human eye tracking unit; and wherein
the human eye tracking unit is used for determining a preset viewing angle range by tracking a target human eye, and sending the determined preset viewing angle range to the control unit; and
the control unit adjusts voltages applied to the sub-electrodes in the electrode units according to the preset viewing angle range.

7. The liquid crystal display according to claim 1, wherein the first transparent electrode is located at a side of the upper substrate facing the liquid crystal layer, and the second transparent electrode is located at a side of the lower substrate facing the liquid crystal layer; or
the second transparent electrode is located at the side of the upper substrate facing the liquid crystal layer, and the first transparent electrode is located at the side of the lower substrate facing the liquid crystal layer.

8. The liquid crystal display according to claim 1, wherein the thicker an equivalent optical path of the micro-prism structure in a direction along a cell thickness of the liquid crystal display, the smaller a difference between voltages applied to the transparent electrodes at both sides of the liquid crystal layer corresponding to the micro-prism structure.

9. The liquid crystal display according to claim 1, wherein the sub-electrodes have a shape of a curved line.

10. The liquid crystal display according to claim 9, wherein the shape of a curved line is a corrugated shape.

11. The liquid crystal display according to claim 1, wherein the sub-electrodes have a polyline shape.

12. The liquid crystal display according to claim 11, wherein the polyline shape is a sawtooth shape.

13. The liquid crystal display according to claim 1, further comprising a first polarizer located between the lower substrate and the backlight.

14. The liquid crystal display according to claim 13, further comprising a second polarizer located at a side of the upper substrate facing away from the liquid crystal layer, and a direction of transmission axis of the second polarizer being parallel to a direction of transmission axis of the first polarizer.

15. The liquid crystal display according to claim 1, wherein the micro-prism structures are triangular prism structures or quadrilateral prism structures.

16. An electronic device comprising the liquid crystal display according to claim 1.

17. The electronic device according to claim 16, wherein the first transparent electrode and the second transparent electrode are located between the upper substrate and the lower substrate.

18. The electronic device according to claim 16, further comprising a light color conversion layer at a side of the liquid crystal layer facing away from the lower substrate; and wherein,
the light color conversion layer is used for converting, into light of at least one color, light in regions corresponding to the micro-prism structures and transmitted through the liquid crystal layer, and light from the backlight is converted into light of at least three colors after being transmitted through the light color conversion layer.

19. The electronic device according to claim 16, further comprising a human eye tracking unit; and wherein
the human eye tracking unit is used for determining a preset viewing angle range by tracking a target human eye, and sending the determined preset viewing angle range to the control unit; and
the control unit adjusts voltages applied to the sub-electrodes in the electrode units according to the preset viewing angle range.

20. The electronic device according to claim 16, wherein the first transparent electrode is located at a side of the upper substrate facing the liquid crystal layer, and the second transparent electrode is located at a side of the lower substrate facing the liquid crystal layer; or
the second transparent electrode is located at the side of the upper substrate facing the liquid crystal layer, and the first transparent electrode is located at the side of the lower substrate facing the liquid crystal layer.
